(19) United States
(12) Patent Application Publication
(10) Pub. No.: US 2019/0005872 A1
(43) Pub. Date: Jan. 3, 2019

(54) METHOD AND SYSTEM FOR PROVIDING COLLIMATED BACKLIGHT ILLUMINATION IN A DISPLAY SYSTEM

(71) Applicant: Pure Depth, Inc., Redwood City, CA (US)

(72) Inventors: John D. NEWTON, Auckland (NZ); James S. EMSLIE, Auckland (NZ); Gareth P. BELL, Auckland (NZ); Abril SAMANO LIRA, San Antonio, TX (US)

(21) Appl. No.: 16/014,202

(22) Filed: Jun. 21, 2018

Related U.S. Application Data
(60) Provisional application No. 62/527,175, filed on Jun. 30, 2017.

(51) Int. Cl. G09G 3/3208; G02B 27/30; F21V 8/00; G02B 27/09

(52) U.S. Cl. CPC G09G 3/3208; G02B 27/30; G09G 2320/0233; G02B 27/0955; G02B 6/002

(57) ABSTRACT

A multi-display system (e.g., a display including multiple display panels) includes at least first and second displays (e.g., display panels or display layers) arranged substantially parallel to each other in order to display three-dimensional (3D) features to a viewer(s). A backlight unit produces and directs collimated light from a top surface of a light guide and towards the first and second displays. An optical element(s) such as at least a refractive beam mapper (RBM) is utilized in order to reduce moire interference and smooth out area luminance distribution of the backlight unit

### CROSS REFERENCE TO RELATED APPLICATION

This application claims the benefit of priority to U.S. Provisional Patent Application No. 62/527,175 filed on Jun. 30, 2017, the entire contents of which is hereby incorporated by reference.

### FIELD OF THE INVENTION

This invention relates to providing illumination (e.g., illumination with collimated backlighting) in a display system. The display system may include one or more displays and may be a multilayer layer display (e.g., a display including at least first and second displays arranged substantially parallel to each other in order to display three-dimensional (3D) features to a viewer(s)). Thus, this invention relates generally to displays and, more particularly, to display systems and methods for providing illumination for displays.

### BACKGROUND AND SUMMARY OF THE INVENTION

Traditionally, displays present information in two dimensions. Images displayed by such displays are planar images that lack depth information. Because people observe the world in three-dimensions, there have been efforts to provide displays that can display objects in three-dimensions. For example, stereo displays convey depth information by displaying offset images that are displayed separately to the left and right eye. When an observer views these planar images they are combined in the brain to give a perception of depth. However, such systems are complex and require increased resolution and processor computation power to provide a realistic perception of the displayed objects.

Multi-component displays including multiple display screens in a stacked arrangement have been developed to display real depth. Each display screen may display its own image to provide visual depth due to the physical displacement of the display screens. For example, multi-display systems are disclosed in U.S. Patent Publication Nos. 2015/0323805 and 2016/0012630, the disclosures of which are both hereby incorporated by reference.

Multi-component displays rely on backlight units to provide illumination to the multiple display screens. One of the challenged with multi-component displays is that the transmission due to multiple displays can be 20% of a standard display system.

There are also efforts to reduce the amount of power that is required to operate conventional backlight units due to limited available power. For example, displays in vehicle dashes (e.g., instrument panels) and portable devices (e.g., PDAs), are restricted in their power consumption requirements due to the limited battery storage capacities. Even small reductions in the power consumption, can improve the performance of devices including the displays (e.g., increases vehicle range).

In addition, displays in application such as vehicle dashes and portable devices, must compete with high ambient light conditions which stop down the users pupils. These displays also compete with reflections from other surfaces (e.g., vehicle interior or user's face and/or clothing) Such constraints place limits on the kind of backlight units that can be used in these application because of a need in increased luminance at lower power consumption. As an example, a multi-component display in a vehicle may need to provide upwards of 800 cd/m̂2 luminance with less than 15 Watts power consumption.

Furthermore, high luminous flux from a backlight unit nay cause a photo-voltaic effect in a rear display of a multi-component display, where the voltages that are held across an LC cell are dependent on transistor not producing a current. Providing too much light incident upon the rear display, may cause current to flow on the pixel electrode, therefore changing the cell voltage,

The backlight units also generate heat that can affect the efficiency and the quality of the display. For example, heat in the backlight unit may be generated by the LED light source due to the down-conversion process. This heat may heat the LED die reducing the efficiency. In addition, the heat from the backlight may cause liquid crystal cells in the display to pass the clearing point resulting in a black panel and/or unreadable display,

Furthermore, light that is emitted in the vertical and horizontal directions outside of the viewing area of a user may be problematic because a reflection can be seen on other nearby surfaces (e.g., in either the driver or passenger side door or the windscreen). Such reflections are unwanted because they can be distracting, and the information will be of the wrong sense or “back to front”. To address this issue automotive display manufacturers put in light control films, however light emitted in directions suppressed by the films is wasted and results a reduction in efficiency (e,g., 20% efficiency reduction),

Certain example embodiments of the instant invention provide solution(s) that reduce power consumption by backlight units, address issues of displays competing with ambient lighting conditions, improve image quality by reducing photo-voltaic effect, improve efficiency, reduce the display components reaching clearing point, reduce unwanted windshield and side windows reflections, and/or address other challenges in multi-component displays.

In example embodiment of this invention, there is provided a display device comprising: a first display in a first plane for displaying a first image; a second display in a second plane for displaying a second image; a backlight unit disposed adjacent to the second display and including a light guide in a third plane, wherein said first, second, and third planes are approximately parallel to each other, and the backlight unit is configured to produce and direct collimated light from a top surface of the light guide and towards the first and second displays; and a beam mapping element disposed between the first and second displays and configured to direct rays output from the second display through sub-pixels of the first display, and to smooth out area luminance distribution of the backlight unit.

In another example embodiment of this invention, there is provided a method of displaying images via a display device including a first display in a first plane for displaying a first image, a second display in a second plane for displaying a second image, a backlight unit disposed adjacent to the second display and including a light guide in a third plane, wherein said first, second, and third planes are approximately parallel to each other, and the backlight unit is configured to produce and direct collimated light from a top surface of the light guide and towards the first and second displays, the method comprising: controlling a beam mapping element, disposed between the first and second displays, to direct rays output from the second display through sub-pixels of the first display, and to smooth out area luminance distribution of the backlight unit.

In another example embodiment of this invention, there is provided a backlight system for providing illumination to a multi-layer display including a first display in a first plane for displaying a first image and a second display in a second plane for displaying a second image, wherein said first and second planes are approximately parallel to each other, the backlight system comprising: a plurality of light emitting diodes; one or more concentrators, each concentrator configured to receive light from one or more of the plurality of light emitting diodes and provide collimated light; and a light guide disposed adjacent to the one or more concentrators, the light guide including a plurality of extraction features provided on a top and/or bottom surface of the light guide, the plurality of extraction features configured spread the collimated light received from the light emitting diodes and/or the one or more concentrators across the top surface of the of the light guide and to direct collimated light towards the first and second displays, wherein the plurality of light emitting diodes, one or more concentrators and the light guide are commonly housed in a housing and the light guide is retained centrally to the housing.

In another example embodiment of this invention, there is provided a backlight system for providing illumination to one or more display layers, the backlight system comprising: a plurality of light emitting diodes; one or more compound parabolic concentrators, each concentrator configured to receive light from one or more of the plurality of light emitting diodes and provide collimated light, at least one of the one or more concentrators including extraction features configured to spread the light received from the one or more of the plurality of light emitting diodes; and a light guide disposed adjacent to the one or more concentrators, the light guide including a plurality of extraction features provided on a top and/or bottom surface of the light guide, the plurality of extraction features configured spread the collimated light received from the light emitting diodes and/or the one or more concentrators across the top surface of the of the light guide and to direct collimated light towards the one or more display layers.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 illustrates a multi-component display according to an embodiment of the present disclosure;

FIG. 2 illustrates a multi-component display according to another embodiment of the present disclosure;

FIGS. 3A and 3B illustrate an exemplary backlight unit disposed adjacent to and between a light diffuser and a reflector;

FIGS. 4A-4C illustrate rays being directed down and/or outside of a light guide;

FIG. 5 is a cross section of a light guide with a concentrator according to an example embodiment of the present disclosure;

FIG. 6 illustrates a light guide including a plurality of concentrators according to an example embodiment of the present disclosure;

FIG. 7A illustrates a light guide including a concentrator according to an example embodiment of the present disclosure;

FIG. 7B illustrates an exemplary plunge depth and transition height of a feature;

FIG. 8 illustrates a process for improving the luminance uniformity provided by a backlight unit;

FIG. 9 is a table with sample requirements and estimated backlight linear expansions;

FIG. 10 illustrates a backlight arrangement according to an embodiment of the present disclosure;

FIG. 11 illustrates a process for improving the luminance uniformity provided by a backlight unit; and

FIG. 12 illustrates an exemplary processing system upon which embodiments of the present disclosure(s) may be implemented.

### DETAILED DESCRIPTION

This invention relates to providing illumination (e.g., illumination with collimated backlighting) in a display system (e.g., a display including at least first and second displays arranged substantially parallel to each other in order to display three-dimensional (3D) features to a viewer(s)). The displays may be flat or curved in different embodiments. Thus, embodiments of this invention relate generally to displays and, more particularly, to display systems and methods for providing illumination for displays displaying three-dimensional features. Multi-Layer Displays (MLDs) according to example embodiments of this invention may be used, for example, as displays in vehicle dashes in order to provide 3D images (e.g., for speedometers, vehicle gauges, vehicle navigation displays, etc.)

Certain example embodiments of the instant invention provide solution(s) that reduce power consumption by backlight units, address issues of displays competing with ambient lighting conditions, improve image quality by reducing photo-voltaic effect, improve efficiency, reduce the display components reaching clearing point, reduce unwanted windshield and side windows reflections, and/or address other challenges in multi-component displays.

Certain example embodiments of this disclosure provide a backlight system for use in a display system (e.g., instrument cluster console) and provide illumination in the viewing direction of one user (e.g., a driver) and at the exclusion of illumination to other users (e.g., passengers) or other areas (e.g., side windows, windshield, or downwards towards the floor). In addition, example embodiments of this disclosure provide a backlight system for use in a display system (e.g., a central information display). The backlight system may allow for the direction of the backlight output to be changed from one user in first location (e.g., a driver) to another user in a second location (e.g., a passenger), or to provide backlight output to both locations (e.g., sides of the display) concurrently. In some embodiments, two light pipes (e.g., two transparent light pipes) could be stacked and controlled to provide backlight to different locations. For example, a rear light pipe may be configured to direct light to one location (e.g., a passenger) and a front light pipe may be configured to direct light to another location (e.g., a driver). In some embodiments, the front and back light may be of the same design but flipped either to the left or right. Whether one or both of the light pipes are controlled to provide backlight may be determined based on a user input(s) (user controls to display information to one or both locations) and/or based on sensors detection presence and/or viewing direction of a viewer/observer.

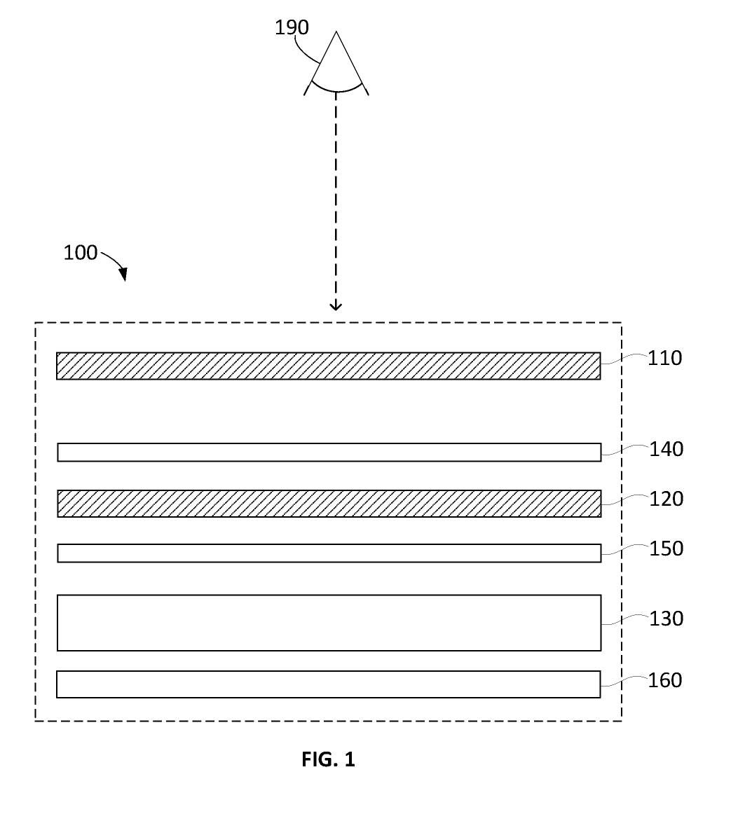

FIG. 1 illustrates a display system 100 including a front display 110, a rear display 120, and a backlight unit 130. The front display 110 and the rear display 120 may be disposed substantially parallel or parallel to each other and/or a surface (e.g., light guide) of the backlight unit 130 in an overlapping manner. In one embodiment, the backlight unit 130 and the displays may be disposed in a common housing. The display system 100 may be provided at the dash of a vehicle in example embodiments of this invention, in order to show the viewer images such as a speedometer, gauges such as oil pressure or fuel level gauges, navigation, etc. It should be appreciated that the elements illustrated in the figures are not drawn to scale, and thus, may comprise different shapes, sizes, etc. in other embodiments.

The display system 100 may display graphical information to a viewer/observer 190, such as an operator or passenger of a vehicle, by displaying information the front and rear displays simultaneously. For example, each of the displays may be controlled to display a different portion of a gauge and/or needle found in a traditional vehicle instrument panel. In certain embodiments, each of the display may be controlled to display a different portion of an image (e.g., clock, gauge and/or needle(s)).

Displays or display layers herein may be LCDs, OLEDs, or the like. Twisted nematic (TN) LCDs may follow a fairly generic pixel layout, such as a square divided into three portions running horizontally (or vertically) with red green and blue sub-pixels. The sub-pixels may be separated by a black mask in the horizontal and vertical directions. There is often a square protrusion in the corner of the sub-pixel to cover the drive transistor. There are several different types of pixel technology that enable wide screen viewing and temporal performance required for modern desktop monitors and televisions. Embodiments of the present invention are compatible with all of these LCDs, since the backplanes are designed to follow the basic RGB stripe pixel layout. As such, the backplane layout required for each pixel not need to change. For example, pixel type displays by manufacturer include: Panasonic (IPS Pro), LG Display (H-IPS & P-IPS), Hannstar (S-IPS), AU Optronics (A-MVA), Samsung (AFFS), S-LCD (S-PVA), and Sharp Corporation (ASV and MVA). In certain embodiments, both displays or display layers may be OLEDs, or one display may be an OLED and the other an LCD. Note that in OLEDs, respective sub-pixels or pixels would be filled with red, green, and blue material as the color filter material (as opposed to having LCD type color filters).

The display system 100 may further include a diffraction component 140, which may be also be an interstitial diffuser, a diffractive optical element (DOE), or a refractive beam mapper (RBM) member, provided between the front display 110 and the rear display 120. The display system 100 may further include a light diffuser 150 provided between the rear display 120 and the backlight unit 130. The display system 100 may also include a reflector 160 provided behind and adjacent to the backlight unit 130. The display system 100 is not limited to components illustrated in FIG. 1. The display system 100 may include additional displays, filter, and/or stationary and/or movable objects disposed in front of the front display 110, between the front display 110 and rear display 120, and/or behind the rear display 120.

The diffraction component 140 may be configured to reduce moire interference due the caused by interactions between the color filters within the layers when projected onto the viewer's retina. The diffraction component 140 may make moire interference in MLD systems vanish or substantially vanish, but without significantly sacrificing the rear display resolution and contrast. In one embodiment, the diffraction component 140 may be a refractive beam mapper (RBM), such a beam mapping element made up of, or including, a plurality of micro-lenses and may be used as a stand-alone element for reducing moire interference via pseudo random mapping.

Examples of reducing moire interference via RBM in multi-display systems are disclosed in U.S. Patent Publication No. 2017/0131558, the disclosure of which is hereby incorporated herein by reference. In certain example pseudo random mapping embodiments, each of the refractive micro-lenses of an RBM may be designed to direct incident rays from the rear display 120 to the observer 190 in a defined path, each ray passing through a different sub-pixel in the front display 110 according to a pseudo random mapping. The pseudo random mapping is used in order to not introduce extra moire effects, and can reduce moire interference. In an example embodiment, the divergence of these individual beams is limited so that light from any pixel or subpixel of the rear display 120 is not diverted more than one pixel or subpixel distance from a straight line on the front display 110. Optionally, the RBM may be laminated to the front display 110, and optionally matched or substantially matched optically to media between the two displays with a non-birefringent material. However, in other embodiments, the refractive beam mapper can be placed anywhere within the LCD stack.

In certain example embodiments, the micro-lenses of an RBM may be fabricated using gray-scale lithography, to produce arbitrary surface structures in a micro-lens format. Each lens element may configured for directing light in a controlled direction enabling arbitrary and asymmetric scattering angles. It is possible to make a master to replicate the RBM using a variety of high-volume manufacturing processes and materials as in the replication of micro-lens features, profile slope angle is more important than profile height. The refractive beam mapper may superimpose rays from the rear display 120 onto the front display 110 from an observer's point of view. The beam paths are mapped in a pseudo random fashion so not to introduce other artifacts such as extra moire. The underlying structure of the rear display 120 is randomized and thus incapable of generating significant moire interference with the front display 110.

Alternatively, a diffuser may instead be used for the construction of a moire suppression element. While the process can be adapted to make a refractive beam mapper, engineered diffusers can also be used as optimal diffuser elements for more reduction.

The refractive beam mapper may exhibit various features. For example, an RBM may exhibit achromatic performance. In addition, an RBM may exhibit arbitrary/asymmetric scattering angles. Further, an RBM may exhibit controlled intensity distribution patterns (e.g., circular, square, rectangular, elliptical, line, ring, etc.). Also, an RBM may exhibit controlled intensity profiles (e.g., flat top, Gaussian, batwing, custom, etc.). An RBM may also exhibit high optical transmission efficiency (e.g., 90 percent). Additionally, an RBM may exhibit the preservation of polarization. An RBM may be of or include various materials, such as polymer injection molding, hot embossed polymers, polymer-on-glass components, etc.

The light diffuser 150 may be configured to even out the light dispersion and at the same time directs the light towards the viewer/observer 190. The light diffuser 150 may reduce the appearance of extraction features in the numeral aperture preserving features of the backlight unit 130. The light diffuser 150 may be a thin sheet of transparent plastic or glass material which has one surface imprinted with small humps and hollows, is placed over the face of the guide to provide in a thin, bright, uniformly lit lambertian surface. In some embodiments, the light diffuser 150 may be an integral part of the backlight unit 130.

The reflector 160 may be configured to reflect light which is emitted from the back side of the light unit 130 back to the light unit 130. In some embodiments, the reflector 160 may be an integral part of the backlight unit 130.

The backlight unit 130 may be configured to illuminate the displays (e.g., liquid crystal displays) in the display system 100. As will be discussed in more detail below it is desirable to provide a backlight unit 130 that collimates the light from an illumination source so that the maximum luminance is provided to the displays.

The luminance in the display system 100 can be decreased due to attenuation of the light by successive displays, diffuser(s), and/or diffraction layer(s) in the display system 100. As an example, the light diffuser 150 illustrated in FIG. 1, will typically have a wide spread angle to hide the lighting elements and gaps between the light extraction elements in the backlight unit 130. In display systems where space is a premium, the light diffuser 150 is also placed as close as possible to the light guide of the backlight unit 130. However, this arrangement causes the scattering angle of the light diffuser 150 to be large due to the light diffuser 150 acting at a small distance from the features that need to be blurred out. The large scattering angle causes an increase in the output angle distribution of the light, therefore decreasing the luminance. Thus there is a competing interest to place the light diffuser 150 further away from the backlight unit 130 to reduce the scattering angle and to place the light diffuser 150 closer to the backlight unit 130 to reduce the space needed for the display system.

To avoid the problem of reduced luminance in the display system 100 and/or to decrease the space needed for the display system, the light diffuser 150 may be omitted and the diffraction component 140 may be configured as a duel-purpose device to both smooth the pixel structures to prevent moire interference and to smooth out area luminance distribution of the backlight unit 130 to increase homogeneity.

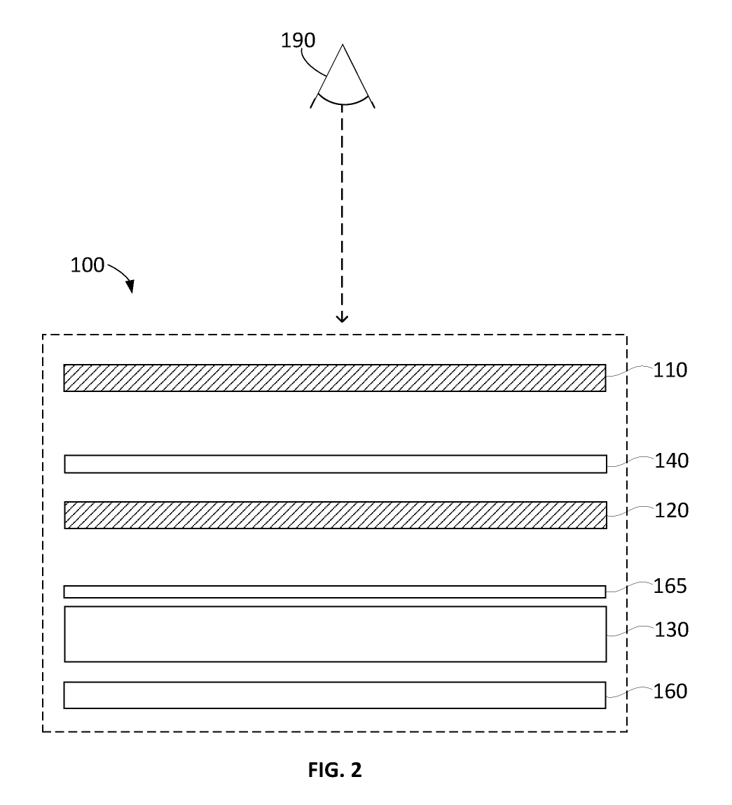

FIG. 2 illustrates a display system 100 including a front display 110, a rear display 120, and a backlight unit 130 with the light source being provided directly adjacent to the rear display 120. In this embodiment, the diffraction component 140 may be configured as a duel-purpose device to both smooth the pixel structures to prevent moire interference and to smooth out the luminance distribution of the backlight unit 130.

Because the diffraction component 140 in FIG. 2 is further away from the backlight unit 130, the scattering angle for the purpose of smoothing out the luminance distribution of the backlight unit 130 can be reduced, thus allowing for the collimation to be maintained. This solution eliminates components of the display system 100 while improving the luminance provided to the viewer/observer 190.

There may be multiple sources of uniformity in the display system. For example, gross non-uniformity may be caused by poor optimization of plunge depth of extraction features down the length of a light pipe of the backlight unit 130. A second uniformity source may be due to the discreet nature of the extraction features in the light pipe. When viewed from the top of the light guide with no diffuser these extraction features may look like a fine linear array of bright lines against a dark background. These bright lines may be at ˜0.3 mm spacing, compared with the dark lines of the black matrix of the rear display 120 (e.g., an LCD panel) which may have 0.16˜0.2 mm spacing.

As discussed above, in the case of the LCD panel, the pixel features of the rear display 120 may give rise to moire interference with the front panel. The human visual system is more sensitive to this lower spatial frequency and so any residual noise pattern will be seen. The trade-off for addressing the pixel features is causing blur to the rear display 120.

In the case of the backlight unit 130 extraction features, these are small and so are more difficult to detect. Also the tradeoff is different for the backlight unit 130 extraction features because more diffusion will cause more angular diffusion and to less luminance. However, the angular spread can be reduced, while maintaining the apparent spread (e.g., a blur kernel acting on the features), by increasing the distance between the diffraction component 140 and the extraction features. This is achieved by the various embodiments of this application by configuring the diffraction component 140 (e.g., RBM) to do both jobs. This also provides an advantage over other arrangements because the diffraction component 140 (e.g., RBM) is already provided further away from the features of the backlight unit 130 (e.g., 3˜5 mm) as compared to being closer (e.g., 1˜2 mm) to the rear panel, which means no additional divergence.

According to one embodiment, the effective full width half maximum (FWHM) of the spreading kernel in microns of the element would need to satisfy the following equations:

FWHM(z1)≈pixel_pitch, and (1)

FWHM(z2)>extraction_pitch. (2)
Where the extraction_pitch is the spacing of the extraction structures in the backlight unit 130, and the diffraction component 140 is placed at distances z1 and z2 from the display subpixels of the rear display 120 and the backlight unit 130 extraction surface, respectively.

In one example for the embodiment illustrated in FIG. 1, with the backlight unit 130 features of 350 microns, the light diffuser 150 would need a 20 degree FWHM kernel spaced at 980 microns from the backlight unit 130. The rear panel 120 could be ˜900 um thick and the diffraction component 140 (e.g., the refractive beam mapper) would be spaced at 230 from the microns from the rear panel subpixel features. In this example, for an initial output distribution from the back panel subpixel features of 20 deg, a final output distribution of sqrt(20 deĝ2+20 deĝ2+20 deĝ2)/2=34 degrees would be produced.

Removing the light diffuser 150, as illustrated in FIG. 2, would results in reduced final output distribution. For the embodiment illustrated in FIG. 2 (in air), with a FWHM of the kernel of 20 degrees and pixel pitch of display of 152 microns, it has been shown experimentally that an effective pixel kernel FWHM of 192 microns is enough to smooth the pixel features out. This implies the diffraction component 140 (e.g., the refractive beam mapper) to subpixel feature distance of 530 microns in air (i.e. 530*tan(20 degrees)=192 microns). The distance between the diffraction component 140 (e.g., the refractive beam mapper) and the backlight unit 130 is the total thickness of the rear display 120, which includes an extra distance of 300 microns for the rear display glass and 150 microns for a polarizer. This arrangement is adequate for features in the backlight unit 130 that are spaced at ˜350 microns. Thus, the diffraction component 140 may be provided directly adjacent to the rear display 120 on one side of the display and the backlight unit 130 may be provide directly adjacent to the opposite side of the rear display 120. In one embodiment, the beam mapping elements or the microlenses of the beam mapping element may be laminated to the second display. If the original output angular distribution of the backlight unit 130 is +/−10 deg in the horizontal, the final output distribution to the viewer will be +/−14 degrees (i.e. sqrt(20 deĝ2+20 deĝ2)/2=(FWHM of 28 deg)). Thus, the final saving is about 5 degrees of output distribution.

For a diffraction component 140 (e.g., the refractive beam mapper) embedded in n=1.42 material, removing the backlight unit 130 diffuser results in the final output distribution to the viewer being +/−12.5 degrees (i.e. sqrt(20 deĝ2+15 deĝ2)/2=(FWHM of 24 deg)). Thus, the final saving is about 10 degrees of output distribution over the original configuration.

In some embodiments, brightness enhancing film (BEF) 165 with features running in the vertical direction of the display may be provided in the display system 100. The brightness enhancing film 165 may include prisms facing the back light unit to direct light in multiple direction (e.g., left and right of the display system 100 for a passenger and a driver).

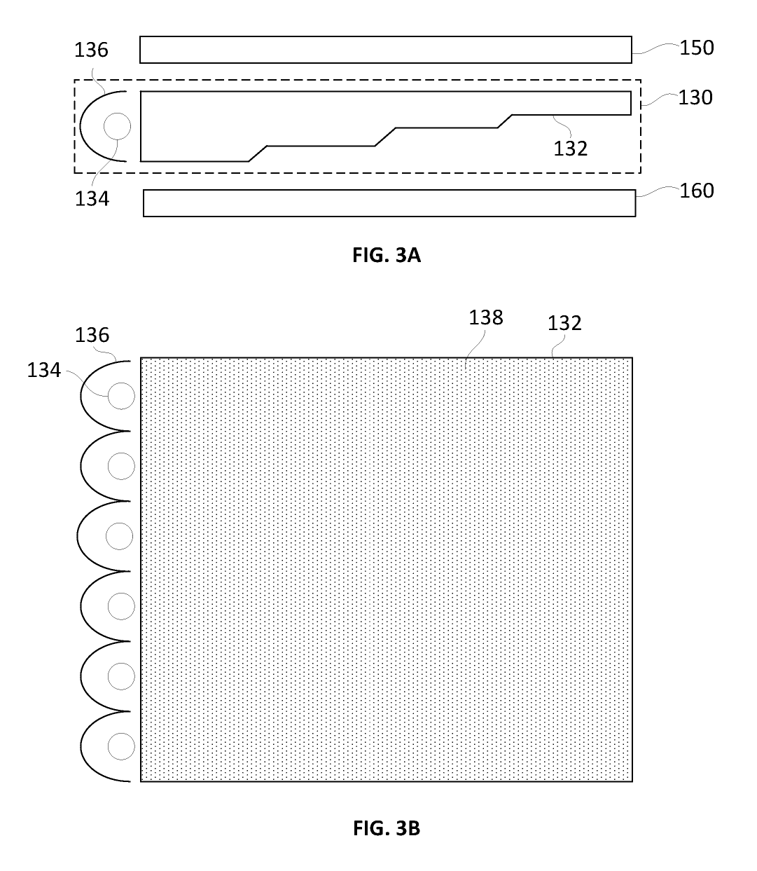

FIGS. 3A and 3B illustrate an exemplary backlight unit 130 disposed adjacent to and between a light diffuser 150 and a reflector 160. As discussed above, the light diffuser 150 and/or the reflector 160 may be optional in some embodiments. In some embodiments, the light diffuser 150 and/or the reflector 160 may be an integral part of the backlight unit 130. The backlight unit 130 may be a collimating backlight providing collimated light at an angle normal (perpendicular) direction to the surface(s) of the displays.

The backlight unit 130 may include a light guide 132 with a substantially planar upper and/or lower surface, but is not so limited. As illustrated in FIG. 3A, the upper surface may be planar and the lower surface may include a plurality of planar portions that are parallel to the upper surface and other planar portions that are provided at an angle relative to the upper surface. While FIG. 3A illustrates a single backlight unit 130 and light guide 132, a plurality of backlight units and/or light guides in each backlight unit may be included in the display system to provide illumination to the displays.

A light source 134, which may be a Light Emitting Diode (LED), may be provided along one or more of the peripheral edges of the light guide 132. The LEDs may be, for example, surface emitting or edge emitting. The LEDs may be selected to provide good efficiency, with a slim design (as additional thickness may to the length of the system), good heat transfer, with surface mount, and/or with a small die (e.g., ˜0.3 mm) to enable placement tolerance. In some embodiments, instead of using separate RGB dies which may cause issues with color non-uniformity, a phosphor white LED method may be used to provide white light in a single LED. The single LED may be configured to combine a short wavelength LED (e.g., a blue or UV), and a phosphor coating to produce the white light. The phosphor white LED may provide better color rendering and improved efficiency as compared to the RGB LEDs. In some embodiments, the LED may include a KSF based tri-color die which provides narrow spectral color bands, and may reduce the need for thick color filters for the same color gamut.

As illustrated in FIG. 3B, a plurality of light sources 134 may be disposed along one edge of the light guide 132. Each of the light sources 134 may be housed within a concentrators 136 configured to reflect the illumination from the respective light source 134 through the peripheral boundary wall of the light guide 132. The concentrators 136 may be parabolic concentrators with mirror like features. In some embodiments, the concentrator 136 may be a concentrator with a straight sided concentrator containing mirror like features, a compound parabolic concentrator with mirrored sides, a compound parabolic concentrator that relies on internal reflection within a higher refractive index medium, or a concentrator with sides that are shaped via cubic splines or other suitable curves. An input section to the concentrator 136 may be curved to accommodate LED domes.

One more of the internal surfaces of the light guide 132 may be provided with a plurality of extraction features 138. In one embodiment, the upper and the lower surface of the light guide 132 is provided with the extraction features 138. The extraction features 138 may help to spread the collimated light across the surface of a flat plane that extends across the rear facing surfaces of the one or more displays. The extraction features 138 may be microlenses. The extraction features 138 may include a birefringent material and/or may have a saw tooth structure, or a curved structure. The spacing, size, geometry of the extraction features 138 may change as the distance from the light source increases. Although FIGS. 3A and 3B show the light guide 132 and concentrator 136 with a hollow area, portions of the light guide 132 and concentrator 136 could be filled with a same or different dielectrics.

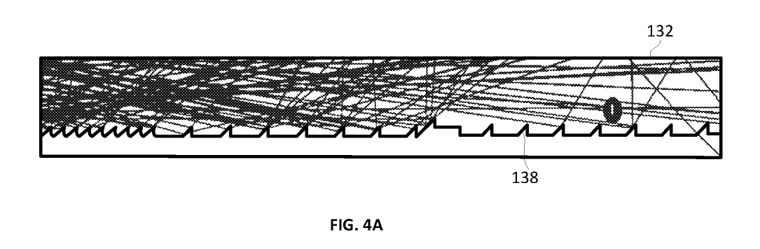

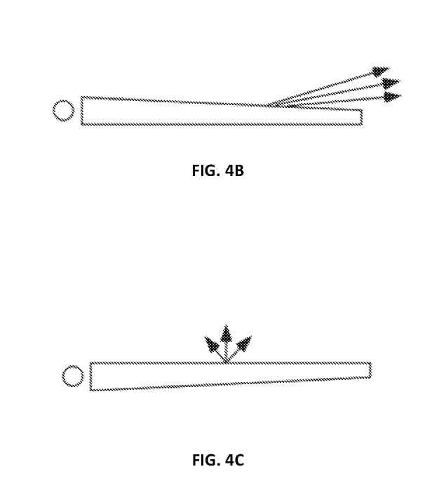

FIG. 4A illustrates rays being directed down the light guide 132 and redirected by the features 138 outside of the light guide 132 and toward the display(s). As shown in FIG. 4A, the concentration of the features 138 at the entrance of the light rays may be higher as compared to the concentration of the features 138 further away from the entrance of the light rays into the light guide 132.

The surfaces and/or the features in the light guide 132 may be arranged to ensure that the numerical aperture of the system does not increase as the light traverses across the surface of the light guide. In one example, the features may be provided with a spacing, height, and/or vertical position such that the area though which the rays are traversed do not exceed preset limits. In some embodiments, the surfaces of the light guide 132 may remain parallel except where there are ejection features 138 provided in the surfaces.

As illustrated in FIG. 4A, the light guide 132 includes rays that are extracted and directed towards the viewer and rays that are reflected and continue to traverse along the length of the light guide 132. The light may be extracted from the light guide 132 via the features 138 (e.g., exit face features) where the entrance angle of the ray and the front exit surface normal does not exceed the angle required for total internal refraction. In this way, the atendue of the light guide 132, which is the product of the numerical aperture and the area though which the rays are traversed, may be conserved. To maintain a constant numeral aperture, any extraction should be accompanied by a corresponding decrease in the light guide 132 cross section height. Thus, the light guide 132 may include a decreasing cross section height from one side to the opposite side of the light guide 132, providing a wedge shape with the thickness decreasing towards the end opposite to the light source side.

The decreasing cross section may be provided by the light guide 132 having one of the front or the back surfaces provided parallel to the front and/or rear displays, and the other of the front or the back surfaces provided at an angle to the front and/or rear displays. For example, FIG. 4B illustrates a front surface configuration of a light guide and FIG. 4C illustrates a back surface configuration a light guide. A light guide 132 with a front face configuration may have the back surface that is parallel to the front and/or rear displays and the front surface (i.e., the surface closer to the panels) that is at an angle to the front and/or rear displays. In the front surface configuration, light from the front surface may disperse from the light pipe such that the light is directed towards an observer located to the side of the display. In the front surface configuration the light may exit parallel to the light pipe surface normal. A light guide 132 with a back surface configuration may have the back surface that is at an angle to the front and/or rear displays and the front surface that is parallel to the front and/or rear displays. In the back surface configuration light may be directed upwards of the display surface. In the back surface configuration light may be directed towards an observer positioned in front of the display system.

In some embodiments, the backlight unit 130 may include a plurality of light pipes. The light pipes may be configured to provide backlight to different locations relative to the display system. For example, two light pipes (e.g., two transparent light pipes with a front surface configuration) could be stacked and controlled to provide backlight to different locations in a vehicle. For example, a rear light pipe with a front surface configuration may be configured to direct light to one location (e.g., a passenger) and a front light pipe with a front surface configuration may be configured to direct light to another location (e.g., a driver). In some embodiments, the front and back light may be of the same design but flipped either to the left or right. Whether one or both of the light pipes are controlled to provide backlight may be determined based on a user input(s) (user controls to display information to one or both locations) and/or based on sensors detection presence and/or viewing direction of a viewer/observer.

In some configurations, surfaces of the light guide 132 (e.g., the optically inactive parallel surfaces) may be adjusted such that their angles are aligned with the flow lines of the light traversing through h the light guide 132. Extraction features adjacent to the optically in-active flow lines features may reflect bundles of rays out towards the displays.

Because in some applications (e.g., automotive applications), strict form factor requirements needs to be satisfied, providing the collimation features outside of the surface of the active areas will allow the backlight system to fit within a narrow bezel, while still providing sufficient collimation to meet other requirements discussed above. This can be achieved by putting numeral aperture preserving extraction features on the surface of the parabolic portion of the light guide 132 (e.g., on a portion of the concentrator). The plunge depth of the features or the reflection angle of these features can be adjusted since the rays at this location are traversing at large angles with respect to the optical axis of the light guide 132.

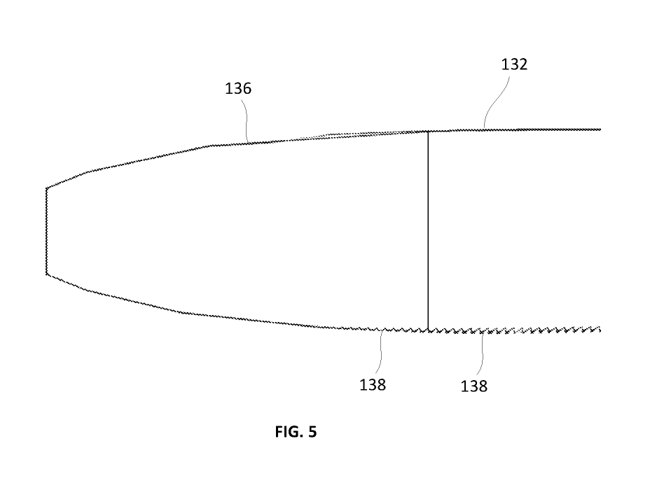

FIG. 5 illustrates cross section of a light guide 132 with a concentrator 136 according to an example embodiment of this invention. The concentrator 136 may be provided on one end of the light guide 132 and/or may be coupled to the light guide 132. The concentrator 136 may be a compound parabolic concentrator (CPC).

Light from the light source may be directed into an opening in the concentrator 136. Light from the light source may be directed by the concentrator into the light guide 132. In one embodiment, the concentrator may collimate the light in both the vertical and horizontal direction simultaneously.

In addition, light that is reflected from the light guide 132 and would otherwise leave the light guide 132 on a side of the light guide 132 may be reflected by the concentrator 136 back into the light guide.

Light from the light source may be directed by the concentrator 136 along the length of the light guide 132. Extraction features on one or more surfaces of the light guide 132 and/or concentrator 136 may reflect the light such that the light is emitted through an upper surface of the light guide 132. As shown in FIG. 5, a portion of the concentrator 136 surface may be provided without extraction features and a portion of the concentrator 136 surface closer to the light guide 132 may be provided with extraction features. In situations where the vertical sides of the surface 142 (e.g. parabola) can be seen when looking at the display's active area, a portion of the vertical faces may be stopped before the active area whilst still maintaining as much collimation as possible.

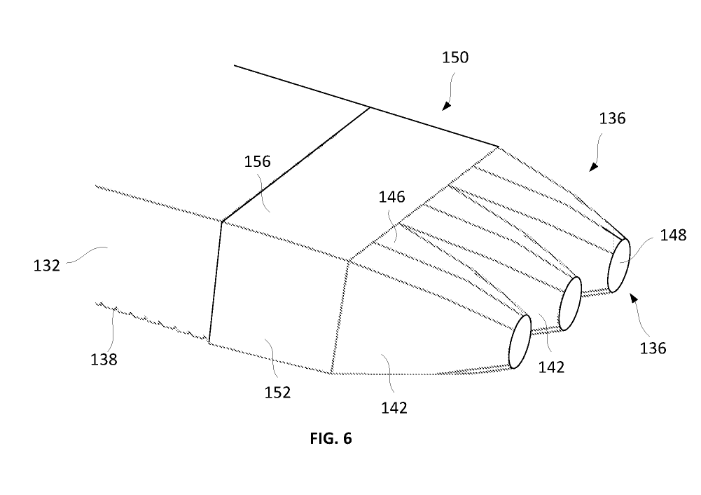

FIG. 6 illustrates a light guide 132 with a plurality of concentrators 136 according to an example embodiment of this invention. The concentrators 136 may be provided adjacent to each other on one end of the light guide 132 and/or may be coupled to the light guide 132. The concentrators 136 may be a compound parabolic concentrator (CPC).

Each of the concentrators 136 may include an opening or surface 148 to accommodate a light source (e.g., a circular opening, a flat surface, a curved surface or a concave surface to receive an LED). Each of the concentrators 136 may include substantially vertical surfaces 142 provided on opposite sides of opening or surface 148. The vertical surfaces 142 of concentrators 136 on the ends may extend to a vertical surface 152 of the concentrator extension portion 150. The vertical surfaces 142 of concentrators 136, which are adjacent to other vertical surfaces 142, may connect and terminate at the concentrator extension portion 150. The substantially horizontal surfaces 146 of the concentrators 136 may be provided on opposite sides of opening or surface 148. The horizontal surfaces 146 of concentrators 136 may extend to a horizontal surface 156 of the concentrator extension portion 150. While in FIG. 6, surfaces 142 and 146 are parabolic, in other embodiments surfaces 142 and 146 may have a planar or a curved shape. Surfaces 142 and/or or 152 may collimate the light in the horizontal direction and surfaces 146 and/or 156 may collimate the light in the vertical direction.

In some embodiments, one or more surfaces of the concentrator may be removed to reduce the expansion and contraction of the backlight unit due to extreme temperature variations. For example, temperature variations in a vehicle, which can range from −40 degrees to 100 degrees Celsius, can cause the backlight unit to expansion and contraction and change the luminance uniformity. Materials with lower thermal expansion can be used in the backlight unit to reduce the expansion and contraction due to temperature changes but such materials require higher processing temperatures which can increase cycle times and therefore cost.

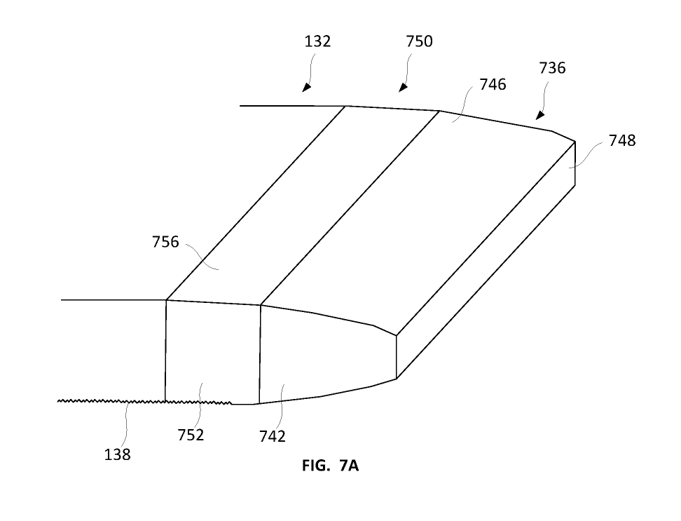

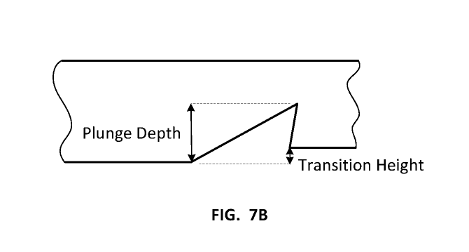

In one example, one or more vertical surfaces of the concentrators may be removed to reduce thermal expansion and contraction. FIG. 7A illustrates a light guide 132 with a concentrator 736 which reduces the number of vertical surfaces provided by the concentrators 136 in FIG. 6. The concentrator 736 may be provided on an end of the light guide 136 and may extend along the end of the light guide 136.

The concentrator may include an opening or surface 748 to accommodate a plurality of light sources (e.g., a circular openings, a flat surface, curved surfaces, or concave surfaces to receive an LED). The concentrator 736 may include substantially vertical surfaces 7 provided on opposite sides of opening or surface 748. The vertical surfaces 742 may extend to a vertical surface 752 of the concentrator extension portion 750. The substantially horizontal surfaces 746 of the concentrators 736 may be provided on opposite sides of opening or surface 748. The horizontal surfaces 746 may extend to a horizontal surface 756 of the concentrator extension portion 750. While in FIG. 7A, surfaces 742 and 756 are planar, surfaces 742 and 756 may have a curved shape in other embodiments.

The concentrator 736 in FIG. 7A may provide reduced collimation of the light in the horizontal direction, as compared to the collimation of the light provided by the concentrators 136 in FIG. 6. Collimation for the embodiment shown in FIG. 7A may be at least partially recovered by including brightness enhancing film with features running in the vertical direction of the display. The brightness enhancing film (BEF) may be provided between the top of the light guide and the display panel. In some embodiments, the brightness enhancing film may be placed with prisms facing the viewer to provide additional collimation. The brightness enhancing film may include prisms facing the back light unit to direct light left and right for the passenger and driver respectively. The prisms may be provided with predetermined pitch and angle geometry to provide light distribution in one or more desired direction. Inverted brightness enhancing film may be used to produce a bimodal light distribution (towards different direction as viewed from the display) to allow, for example, a passenger and a driver to view the display (e.g., a centrally placed display in a vehicle). Short collimation features may be used with the brightness enhancing film to recover light from extreme angles in the horizontal direction where light would normally pass through the film unaffected.

Due to variations in the irradiance and radiance as emitted by the concentrator regions, and total internal reflections from the top surface of the light guide, there may be bright and dim regions along the height of the light guide. The amount of light coming out of any one region of the light guide may be modulated by adjusting the so-called plunge depth of the feature, the transition height between one feature and the next, and/or the spacing between features. FIG. 7B illustrates an exemplary plunge depth and transition height of a feature. The plunge depth may correspond to the height of the feature from the surface of the light guide (e.g., back or front surface of the light guide). The transition height may correspond to the height difference of the surface (e.g., back or front surface of the light guide) between where the feature starts and ends. For example, in situations where less light is desired the plunge depth and/or transition height can be decreased, and/or the features spacing may be increased. In situations where more light is desired the plunge depth and/or transition height can be increased, and/or the feature spacing may be decreased.

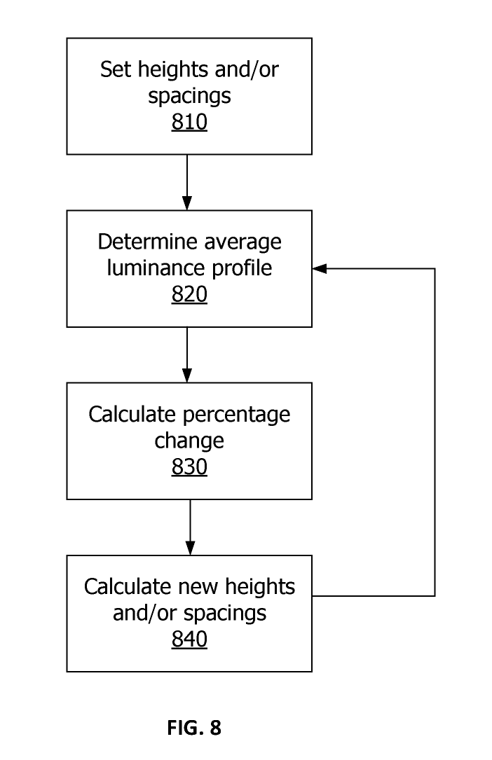

This process may be performed in an iterative loop until a desired luminance uniformity is achieved. FIG. 8 illustrates a process that may be performed to improve the luminance uniformity provided by a backlight unit. One or more steps of the process may be performed by computer system including one or more processors and one or more software modules including program instructions.

In step 810, a first setting for the feature heights and/or spacings are made. Providing the first setting for the feature heights and/or spacings may include setting the heights and/or spacings to preset values, even values, and/or random values (e.g., within respective preset ranges). In step 820, a trace of the system is made and a profile of the average luminance in the x direction is determined. In step 830, a percentage change from the mean is calculated. In step 840, a new transition height and/or plunge depth profile is calculated by multiplying the original profile by the inverse of the inverse of the original profile.

The process in FIG. 8 may be performed for the feature heights, while the feature spacings are maintained constant. Alternatively, the process in FIG. 8 may be performed for the feature spacings, while the feature heights are maintained constant. In some embodiments, the process in FIG. 8 may be performed for one of the feature heights or spacing, and then repeated for the other one of the feature heights or spacing.

The components of the backlight unit may be produced by case or injection molding, over molded (e.g., for high-fidelity material such as silicon), or hot embossed, but is not so limited. Sample materials that may be used for molding include Poly Methyl Methacrylate, polycarbonate, Grillamid, and Cyclic Olefin Copolymer.

As discussed above, the light guide may decrease in thickness from the end at which the light is injected. In conjunction with various diffusion elements that are placed after the light extraction features, the feature spacing may need to be such that the features are blurred out by an interstitial diffuser element (e.g., diffraction component 140 illustrated in FIG. 4A) provided between the front and rear displays. Diffusing any further may not be desirable because this may increase the viewing cone outside of the optimized viewing cone.

As discussed above, the thermal expansion of the backlight unit needs to be considered for application with high temperature variations. For example, temperature variations in a vehicle, which can range from −40 degrees to 100 degrees Celsius, can cause changes in the luminance uniformity of the backlight unit. As an example, high temperature variations should be considered because some optical collimators require alignment to be within +−˜0.5 and the high transmission plastics in some embodiments may change size by ˜1 mm in these conditions. Example calculations are provided below for acrylic and polycarbonate plastics with respect to aluminum or copper board substrates.

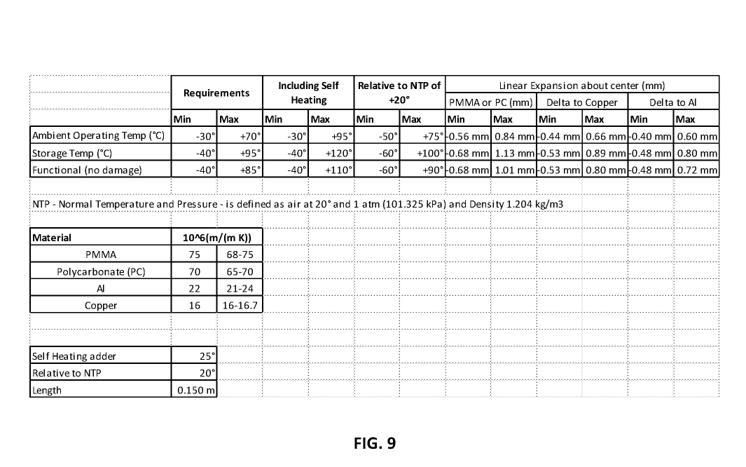

When an object is heated or cooled, its length changes by an amount proportional to the original length and the change in temperature. The linear thermal expansion of an object can be expressed as d1=L₀α (t₁−t₀), where d1 is change in object length (m, inches); L₀ is initial length of object (m, inches); α is linear expansion coefficient (m/m° C., in/in° F.); to is initial temperature (° C., ° F.); and ti is final temperature (° C., ° F.). Sample requirements and estimated backlight linear expansion about the centre are provided in the table shown in FIG. 9.

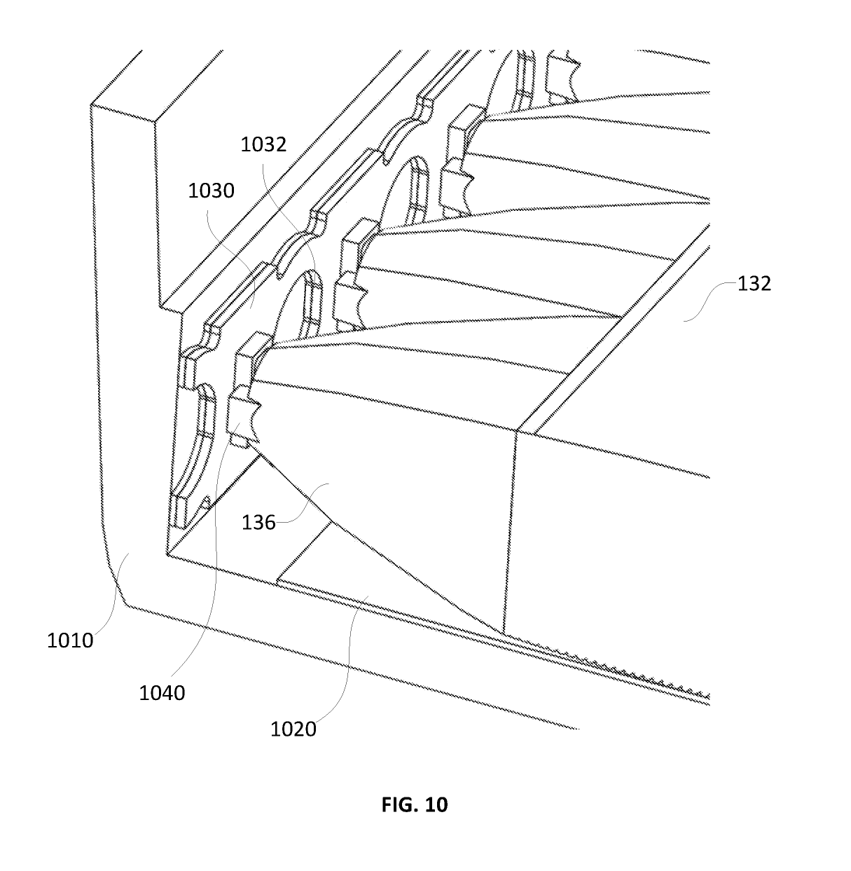

FIG. 10 illustrates a backlight arrangement according to an embodiment of the present disclosure. The light guide 132 may be retained centrally within a housing 1010 on a horizontal plane 1020, which may be coupled directly or indirectly to the housing 1010. In some embodiments, the light guide 132 may be retained centrally (directly or indirectly) to the housing 1010. Centrally retaining the light guide 132 allows for the light guide 132 to distribute the expansion of the light guide 132 from the center of the light guide 132 over multiple directions (e.g., both directions parallel to the displays). The concentrators 136 are coupled to the light guide 132 and are aligned with the light source (e.g., LED) provided with a circuit board 1030. The LED may be attached and/or provided as part of the circuit board 1030. One or more component of the display device not illustrated in FIG. 10 (e.g., displays) may also be at least partially provided inside of the housing 1010.

The circuit board 1030 may include a substrate supporting and driving the plurality of light sources and an expansion joint 1032. Retention structures 1040 are provided on the end of the concentrators 136 and are configured to movably engage the expansion joints 1032 to tie the optical center of the concentrator 136 to the optical center of the light source coupled to the circuit board 1030. As shown in FIG. 10, the retention structures 1040 may have surfaces that at least partially correspond to surfaces in the expansion joints 1032, thus allowing for the light guide 132 and concentrators 136 to move in one or more directions (e.g., direction parallel to a central axis of the concentrator 136) relative to the circuit board 1030. With this configuration, proper alignment of the center point of the concentrator 136 on the light guide 132 and respective light source may be maintained. The retention structures 1040 may also be configured to maintain a cap between the light guide 132 with the concentrators 136 and the circuit board 1030, and/or maintain pressure between the circuit board 1030 and the housing 1010 to prevent delamination.

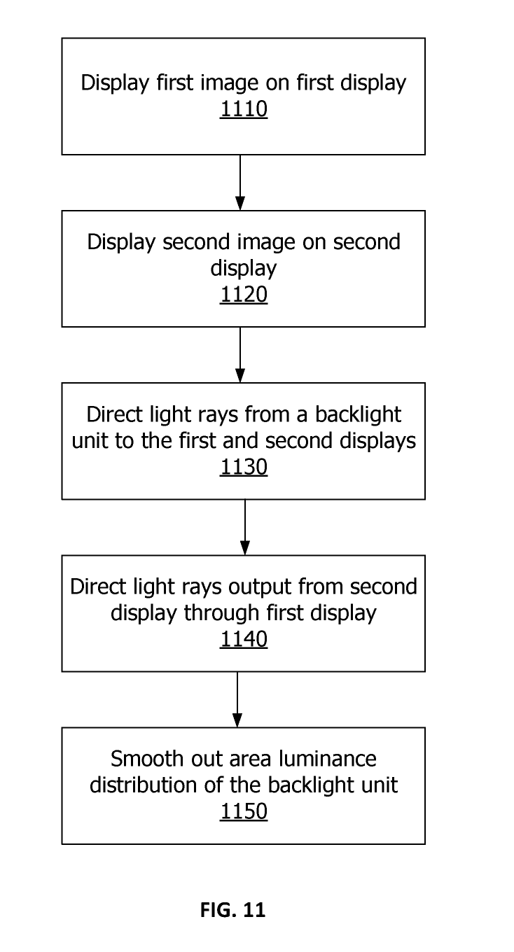

FIG. 11 illustrates a process that may be performed to improve the luminance uniformity provided by a backlight unit. One or more steps of the process may be performed by computer system including one or more processors and one or more software modules including program instructions. In step 1110, a first image is displayed on a first display. In step 1120, a second image is displayed on a second display. The first and second images may be displayed simultaneously on the respective displays. In step 1130, a backlight unit may be controlled to produce and direct collimated light towards the first display and second display. In step 1140, light rays output from the second display through the first display. The light rays output from the second display may be directed through sub-pixels of the first display and toward a viewer, via a plurality of microlenses having a substantially square profile as viewed from the point of view of a viewer, the microlenses being located between the first and second displays. The rays from a given subpixel in the second display may be directed toward multiple different subpixels of the first display, and the rays from a plurality of different subpixels of the second display proceeding through a given subpixel of the first display. In step 1150, the luminance distribution of the backlight unit is smoothed out. The luminance distribution of the backlight unit may be smoothed out by controlling the microlenses being located between the first and second displays.

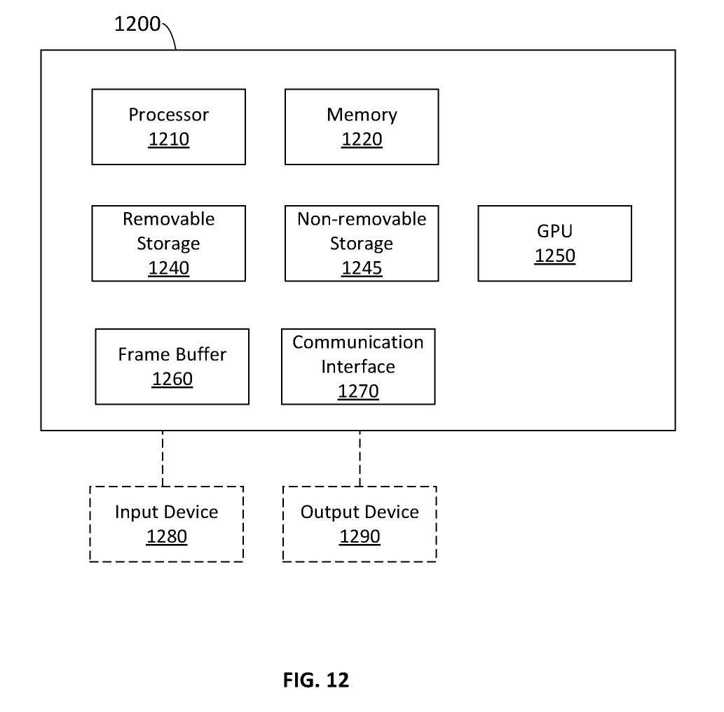

FIG. 12 illustrates an exemplary processing system 1200 upon which embodiments of the present disclosure(s) may be implemented. The processing system 1200 may include one or more processors 1210 and memory 1220. The processor 1210 may comprise a central processing unit (CPU) or other type of processor. Depending on the configuration and/or type of computer system environment, the memory 1220 may comprise volatile memory (e.g., RAM), non-volatile memory (e.g., ROM, flash memory, etc.), or some combination of the two. Additionally, memory 1220 may be removable, non-removable, etc.

In other embodiments, the processing system may comprise additional storage (e.g., removable storage 1240, non-removable storage 1245, etc.). Removable storage 1240 and/or non-removable storage 1245 may comprise volatile memory, non-volatile memory, or any combination thereof Additionally, removable storage 1240 and/or non-removable storage 1245 may comprise CD-ROM, digital versatile disks (DVD) or other optical storage, magnetic cassettes, magnetic tape, magnetic disk storage or other magnetic storage devices, or any other medium which can be used to store information for access by processing system 1200.

As illustrated in FIG. 12, the processing system 1200 may communicate with other systems, components, or devices via communication interface 1270. Communication interface 1270 may embody computer readable instructions, data structures, program modules or other data in a modulated data signal (e.g., a carrier wave) or other transport mechanism. By way of example, communication interface 1270 may be couple to wired media (e.g., a wired network, direct-wired connection, etc.) and/or wireless media (e.g., a wireless network, a wireless connection utilizing acoustic, RF, infrared, or other wireless signaling, etc.).

Communication interface 1270 may also couple the processing system 1200 to one or more input devices 1280 (e.g., a keyboard, mouse, pen, voice input device, touch input device, etc.) and/or output devices 1290 (e.g., a display, speaker, printer, etc.). The input devices 1280 may be used by an observer to manipulate the way information is displayed on an output device 1290 and/or what information and/or graphics are displayed in different portion of the output device 1290. In one embodiment, communication interface 1270 may couple the processing system 1200 to a display including three or more display panels arranged in an overlapping manner

As shown in FIG. 12, a graphics processor 1250 may perform graphics/image processing operations on data stored in a frame buffer 1260 or another memory of the processing system. Data stored in frame buffer 1260 may be accessed, processed, and/or modified by components (e.g., graphics processor 1250, processor 1210, etc.) of the processing system 1200 and/or components of other systems/devices. Additionally, the data may be accessed (e.g., by graphics processor 1250) and displayed on an output device coupled to the processing system 1200. Accordingly, memory 1220, removable storage 1240, non-removable storage 1245, frame buffer 1260, or a combination thereof, may comprise instructions that when executed on a processor (e.g., 1210, 1250, etc.) implement a method of processing data (e.g., stored in frame buffer 1260) for improved display quality on a display.

As shown in FIG. 12, portions of the present invention may be comprised of computer-readable and computer-executable instructions that reside, for example, in a processing system 1200 and which may be used as a part of a general purpose computer network (not shown). It is appreciated that processing system 1200 is merely exemplary. As such, the embodiment in this application can operate within a number of different systems including, but not limited to, general-purpose computer systems, embedded computer systems, laptop computer systems, hand-held computer systems, portable computer systems, stand-alone computer systems, game consoles, gaming systems or machines (e.g., found in a casino or other gaming establishment), or online gaming systems.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

In example embodiments of this invention, there is provided a display device comprising: a first display in a first plane for displaying a first image; a second display in a second plane for displaying a second image; a backlight unit disposed adjacent to the second display and including a light guide in a third plane, wherein said first, second, and third planes are approximately parallel to each other, and the backlight unit is configured to produce and direct collimated light from a top surface of the light guide and towards the first and second displays; and a beam mapping element disposed between the first and second displays and configured to direct rays output from the second display through sub-pixels of the first display, and to smooth out area luminance distribution of the backlight unit.

In the display device of the immediately preceding paragraph, the beam mapping element may be disposed directly adjacent to one side of the second display and the backlight unit may be disposed directly adjacent to the opposite side of the second display.

In the display device of any of the preceding two paragraphs, the light guide may include a plurality of extraction features configured to direct collimated light towards the first and second displays and spread the collimated light across the top surface of the of the light guide, and the backlight may further comprise, one or more concentrators disposed adjacent to a first side of the light guide; and one or more light emitting diodes configured to produce light to each of the concentrators, and wherein the one or more concentrators are configured to direct the light from the light emitting diodes into the light guide and toward a second side of the light guide.

In the display device of any of the preceding three paragraphs, the display device may further comprise a housing, and the first display, the second display, and wherein the beam mapping element are commonly housed by the housing, the light guide is retained centrally to the housing, the one or more light emitting diodes are disposed on a circuit board, and the circuit board includes an expansion joint configured to engage one or more retention structures provided on the one or more concentrators.

In the display device of any of the preceding four paragraphs, the display device may further comprises a housing, and the first display, the second display, the backlight unit, and the beam mapping element are at least partially provided in the housing, and the light guide is retained centrally to the housing.

In the display device of any of the preceding five paragraphs, the beam mapping element may have a refractive beam mapper.

In the display device of any of the preceding six paragraphs, the beam mapping element may direct rays output from the second display in a pseudo random manner through sub-pixels of the first display and toward a viewer.

In the display device of any of the preceding seven paragraphs, the second display may be a rear display, and the first display may be a front display, of the display device.

In the display device of any of the preceding eight paragraphs, rays from a given subpixel in the second display may be directed toward multiple different subpixels of the first display, and rays from a plurality of different subpixels of the second display may proceed through a given subpixel of the first display.

In another example embodiment of this invention, there is provided a method of displaying images via a display device including a first display in a first plane for displaying a first image, a second display in a second plane for displaying a second image, a backlight unit disposed adjacent to the second display and including a light guide in a third plane, wherein said first, second, and third planes are approximately parallel to each other, and the backlight unit is configured to produce and direct collimated light from a top surface of the light guide and towards the first and second displays, the method comprising: controlling a beam mapping element, disposed between the first and second displays, to direct rays output from the second display through sub-pixels of the first display, and to smooth out area luminance distribution of the backlight unit.

In the method of the immediately preceding paragraph, the beam mapping element may be disposed directly adjacent to one side of the second display and the backlight unit may be disposed directly adjacent to the opposite side of the second display.

In the method of the preceding two paragraphs, the light guide may include a plurality of extraction features directing collimated light towards the first and second displays and spreading the collimated light across the top surface of the of the light guide, and the backlight may further include: one or more concentrators disposed adjacent to a first side of the light guide; and one or more light emitting diodes providing light to each of the concentrators, and wherein the one or more concentrators are configured to direct the light from the light emitting diodes into the light guide and toward a second side of the light guide.

In the method of any of the preceding two paragraphs, the beam mapping element may include a refractive beam mapper.

In another example embodiment of this invention, there is provided a backlight system for providing illumination to a multi-layer display including a first display in a first plane for displaying a first image and a second display in a second plane for displaying a second image, wherein said first and second planes are approximately parallel to each other, the backlight system comprising: a plurality of light emitting diodes; one or more concentrators, each concentrator configured to receive light from one or more of the plurality of light emitting diodes and provide collimated light; and a light guide disposed adjacent to the one or more concentrators, the light guide including a plurality of extraction features provided on a top and/or bottom surface of the light guide, the plurality of extraction features configured spread the collimated light received from the light emitting diodes and/or the one or more concentrators across the top surface of the of the light guide and to direct collimated light towards the first and second displays, wherein the plurality of light emitting diodes, one or more concentrators and the light guide are commonly housed in a housing and the light guide is retained centrally to the housing.

In the backlight system of preceding two paragraphs, extraction features may be provided at a curved surface of the one or more concentrators.

In the backlight system of any of the preceding three paragraphs, the backlight system may further include a circuit board including an expansion joint configured to engage one or more retention structures provided on each of the one or more concentrators, and the light emitting diodes may be disposed on the circuit board.

In the backlight system of any of the preceding four paragraphs, the first display and the second display may be provided at least partially in the housing.

In another example embodiment of this invention, there is provided a backlight system for providing illumination to display layers for displaying images, the backlight system comprising: a plurality of light emitting diodes; one or more compound parabolic concentrators, each concentrator configured to receive light from one or more of the plurality of light emitting diodes and provide collimated light, at least one of the one or more concentrators including extraction features configured to spread the light received from the one or more of the plurality of light emitting diodes; and a light guide disposed adjacent to the one or more concentrators, the light guide including a plurality of extraction features provided on a top and/or bottom surface of the light guide, the plurality of extraction features configured spread the collimated light received from the light emitting diodes and/or the one or more concentrators across the top surface of the of the light guide and to direct collimated light towards the one or more display layers.

In the backlight system of the preceding paragraph, the backlight system may further include a brightness enhancing film adjacent to the top surface of the light guide, the brightness enhancing film including prisms configured to provide bimodal light distribution by directing the light emitted across the top surface of the light guide in multiple directions.

Embodiments according to the present disclosure are thus described. While the present disclosure has been described in particular embodiments, it should be appreciated that the disclosure should not be construed as limited by such embodiments.

What is claimed is:

1. A display device comprising:
a first display in a first plane for displaying a first image;
a second display in a second plane for displaying a second image;
a backlight unit disposed adjacent to the second display and including a light guide in a third plane, wherein said first, second, and third planes are approximately parallel to each other, and the backlight unit is configured to produce and direct collimated light from a top surface of the light guide and towards the first and second displays; and
a beam mapping element disposed between the first and second displays and configured to direct rays output from the second display through sub-pixels of the first display, and to smooth out area luminance distribution of the backlight unit.

2. The display device of claim 1, wherein the beam mapping element is disposed directly adjacent to one side of the second display and the backlight unit is disposed directly adjacent to the opposite side of the second display.

3. The display device of claim 1, wherein the light guide includes a plurality of extraction features configured to direct collimated light towards the first and second displays and spread the collimated light across the top surface of the of the light guide, and the backlight further comprises:
one or more concentrators disposed adjacent to a first side of the light guide; and
one or more light emitting diodes configured to produce light to each of the concentrators, and wherein the one or more concentrators are configured to direct the light from the light emitting diodes into the light guide and toward a second side of the light guide.

4. The display device of claim 3, further comprising a housing, and the first display, the second display, and the beam mapping element are commonly housed by the housing, the light guide is retained centrally to the housing, the one or more light emitting diodes are disposed on a circuit board, and the circuit board includes an expansion joint configured to engage one or more retention structures provided on the one or more concentrators.

5. The display device of claim 1, wherein display device further comprises a housing, and the first display, the second display, the backlight unit, and the beam mapping element are at least partially provided in the housing, and the light guide is retained centrally to the housing.

6. The display device of claim 1, wherein the beam mapping element comprises a refractive beam mapper.

7. The display device of claim 1, wherein the beam mapping element is configured to direct rays output from the second display in a pseudo random manner through sub-pixels of the first display and toward a viewer.

8. The display device of claim 1, wherein the second display is a rear display, and the first display is a front display, of the display device.

9. The display device of claim 1, wherein rays from a given subpixel in the second display are directed toward multiple different subpixels of the first display, and wherein rays from a plurality of different subpixels of the second display proceed through a given subpixel of the first display.

10. A method of displaying images via a display device including a first display in a first plane for displaying a first image, a second display in a second plane for displaying a second image, a backlight unit disposed adjacent to the second display and including a light guide in a third plane, wherein said first, second, and third planes are approximately parallel to each other, and the backlight unit is configured to produce and direct collimated light from a top surface of the light guide and towards the first and second displays, the method comprising:
controlling a beam mapping element, disposed between the first and second displays, to direct rays output from the second display through sub-pixels of the first display, and to smooth out area luminance distribution of the backlight unit.

11. The method of claim 10, wherein the beam mapping element is disposed directly adjacent to one side of the second display and the backlight unit is disposed directly adjacent to the opposite side of the second display.

12. The method of claim 10, wherein the light guide includes a plurality of extraction features configured to direct collimated light towards the first and second displays and spread the collimated light across the top surface of the of the light guide, and the backlight further comprises:
one or more concentrators disposed adjacent to a first side of the light guide; and
one or more light emitting diodes configured to provide light to each of the concentrators, and wherein the one or more concentrators are configured to direct the light from the light emitting diodes into the light guide and toward a second side of the light guide.

13. The method of claim 10, wherein the beam mapping element comprises a refractive beam mapper.

14. A backlight system for providing illumination to a multi-layer display including a first display in a first plane for displaying a first image and a second display in a second plane for displaying a second image, wherein said first and second planes are approximately parallel to each other, the backlight system comprising:
a plurality of light emitting diodes;
one or more concentrators, each concentrator configured to receive light from one or more of the plurality of light emitting diodes and provide collimated light; and
a light guide disposed adjacent to the one or more concentrators, the light guide including a plurality of extraction features provided on a top and/or bottom surface of the light guide, the plurality of extraction features configured spread the collimated light received from the light emitting diodes and/or the one or more concentrators across the top surface of the of the light guide and to direct collimated light towards the first and second displays, wherein the plurality of light emitting diodes, one or more concentrators and the light guide are commonly housed in a housing and the light guide is retained centrally to the housing.

15. The backlight system of claim 14, wherein extraction features are provided at a curved surface of the one or more concentrators.

16. The backlight system of claim 14, wherein the backlight system further comprises a circuit board including an expansion joint configured to engage one or more retention structures provided on some or all of the one or more concentrators, and wherein the light emitting diodes are disposed on the circuit board.

17. The backlight system of claim 14, wherein the first display and the second display are provided at least partially in the housing.

18. A backlight system for providing illumination to one or more display layers, the backlight system comprising:
a plurality of light emitting diodes;
one or more compound parabolic concentrators, each concentrator configured to receive light from one or more of the plurality of light emitting diodes and provide collimated light, at least one of the one or more concentrators including extraction features configured to spread the light received from the one or more of the plurality of light emitting diodes; and
a light guide disposed adjacent to the one or more concentrators, the light guide including a plurality of extraction features provided on a top and/or bottom surface of the light guide, the plurality of extraction features configured spread the collimated light received from the light emitting diodes and/or the one or more concentrators across the top surface of the of the light guide and to direct collimated light towards the one or more display layers.

19. The backlight system of claim 18, further comprising a brightness enhancing film adjacent to the top surface of the light guide, the brightness enhancing film including prisms configured to provide bimodal light distribution by directing the light emitted across the top surface of the light guide in multiple directions.
